(19) United States
(12) Patent Application Publication
(10) Pub. No.: US 2005/0220303 A1
(43) Pub. Date: Oct. 6, 2005

(54) Recording data recording method, recording data reproduction method, recording device, reproduction device, and multi-layered optical recording medium

(76) Inventors: Tetsuro Mizushima, Tokyo (JP); Tsuyoshi Komaki, Tokyo (JP)

Correspondence Address: GREENBLUM & BERNSTEIN, P.L.C., 1950 ROLAND CLARKE PLACE, RESTON, VA, 20191, US

(21) Appl. No.: 10/508,947

(22) PCT Filed: Apr. 3, 2003
(86) PCT No.: PCT/JP03/04304

§ 371 Date: Oct. 1, 2004

(30) Foreign Application Priority Data
Apr. 3, 2002 (JP) 2002100750

(51) Int. Cl. H04N 7/167

(52) U.S. Cl. 380/201

(57) ABSTRACT

The recording data-recording method according to the present invention records recording data encrypted based on a predetermined encryption code on a multilayer optical recording medium comprising two recording layers of a L1 recording layer and a L0 recording layer deposited on at least one side of a substrate. In doing this, the distance between a reference point in the L1 recording layer as a second layer, as counted from an incident direction of a reproduction laser beam or a recording laser beam, and a reference point in the L0 recording layer as a second recording layer, as counted from the incident direction is obtained, and the recording data is encrypted using distance information enabling identification of the obtained distance as the encryption code. This makes it possible to reliably restrict reproduction of recording data from an optical recording medium to which the recording data is copied, while reducing burden on an authorized user.

### TECHNICAL FIELD

This invention relates to a recording data-recording method and a recording device, for recording of recording data after encrypting the recording data, a recording data-reproducing method and a reproduction device, for decrypting the encrypted recording data and thereby reproducing the recording data, and a multilayer optical recording medium having program data recorded thereon for decrypting the encrypted recording data.

### BACKGROUND ART

Today, various types of optical recording media are widely used, which capture attention with their capability of recording large amounts of recording data. In this case, as the method of protecting recording data for prevention of unauthorized copying of recording data recorded on the optical recording media, there are conventionally known a method of setting an attribute of recording data e.g. to invisible, a method of recording of recording data in a special format, and so forth. However, even if these recording data-protecting methods are employed, recording data can be relatively easily copied e.g. by using a personal computer. For this reason, a recording data-protecting method has been devised which protects recording data by recording the same after encryption based on a predetermined encryption code, to thereby make it impossible for a third party to reproduce (decrypt) the recording data even if unauthorized copying of an optical recording medium having the recording data recorded thereon is carried out. In this recording data-protecting method, recording data is recorded on the optical recording medium after alteration (encryption) of the data structure of the recording data according to a predetermined algorithm e.g. using an encryption code (e.g. a character string consisting of numerals and alphabetical letters) which can be known only by an authorized user of the recording data. This protects the recording data recorded on the optical recording medium from unauthorized reproduction by a third party, since the original data of the recording data is made unrecognizable even if the contents of the recording data are directly viewed using a text editor, a binary editor or the like.

Further, when the encrypted recording data is reproduced by the authorized user, first, the recording data is decrypted using a dedicated decryption program. In doing this, the reproduction device prompts the user to input the encryption code according to the decryption program, and reconstructs (decrypts) the data structure of the recording data according to a procedure reverse to the above predetermined algorithm using the inputted encryption code. In this process, if an encryption code which is different from the encryption code used in encryption of the recording data is inputted, the reproduction device decrypts the recording data using the encryption code different from that used in the encryption. Therefore, the decrypted recording data has a data structure (in a irreproducible state) different from that of the recording data before encryption, whereby the recording data is protected from the unauthorized reproduction by a third party. This enables only the user who can know the encryption code used for encryption of the recording data to properly decrypt the encrypted recording data into the recording data before encryption and reproduce the recording data.

On the other hand, Japanese Laid-Open Patent Publication (Kokai) No. H07-21697 discloses the technique of inhibiting reproduction of recording data recorded in an optical recording medium formed by unauthorized copying (hereinafter referred to as “the copy medium”), by recording an identification data ID peculiar to the optical recording medium in a lead-in area. More specifically, an identification data ID is formed by a combination of letters representative of pointer information on pointers specifying recording respective locations of recording data recorded on an original optical recording medium (hereinafter referred to as “the original medium”) and author information on authors or the like of the recording data, and the identification data ID is recorded in a lead-in area together with the pointer information and the author information. In this case, when this kind of optical recording medium is copied by a general copying method, the various pieces of information stored in the lead-in area are not read out from the original medium to be copied into the copy medium, but pointer information and the like newly generated based on recording locations of recording data copied to the copy medium are recorded in the lead-in area of the copy medium. Therefore, when the original medium is copied to another optical recording medium by a general copying method, since the identification data ID is not copied to the copy medium, no identification ID exists in the copy medium.

Further, this optical recording medium (original medium) stores a program as recording data. The program describes a process that first determines, when it is started after being read out from the optical recording medium, whether or not there exists identification data ID in the lead-in area of the medium to thereby determine whether the optical recording medium is an original medium. Therefore, when reproduction of the recording data recorded on the copy medium (execution of the program) is attempted, since the identification data ID does not exist in the lead-in area of the copy medium, it is determined according to the description of the program that the medium used is the copy medium, so that the reproduction of the recording data thereafter is inhibited. Further, when the original medium is copied by the general copying method, the recording locations of the recording data in the original medium are different from those of the corresponding recording data in the copy medium. Therefore, even if identification data ID is copied to the lead-in area of a copy medium, the pointer information corresponding to the identification data ID and the pointer information corresponding to the recording locations of the recording data copied to the copy medium do not coincide with each other. For this reason, it is determined according to the description of the program that the medium used is the copy medium, so that the reproduction of the recording data thereafter is inhibited. Thus, the reproduction of the recording data recorded in the copy medium is inhibited.

### DISCLOSURE OF THE INVENTION

The present inventors studied the recording data-protecting methods described above, and eventually has found out the following problems: According to the recording data-protecting method based on encryption, the reproduction of recording data recorded on an optical recording medium by a third party is restricted by recording the recording data after encryption thereof based on an encryption code which can be known only by an authorized user of the recording data. However, when the recording data is reproduced which is protected (encrypted) by this recording data-protecting method, it is necessary to input the encryption code used in encryption to thereby cause the reproduction device to decrypt the recording data. For this reason, there arises a problem that the operation of inputting the encryption code is very troublesome. Further, according to this recording data-protecting method, even if a person is an authorized user, insofar as the user does not remember an encryption code, the recording data cannot be decrypted (reproduced). In this case, if a memo of the encryption data is made so as to prevent the encryption data used in encryption from being lost in oblivion, there is a fear of the memo being stolen for use by a third party to decrypt the recording data. Further, when wrong encryption data is inputted by mistake when decrypting the recording data, the recording data is prevented from being decrypted into the state before encryption, which makes it impossible to reproduce the recording data. For this reason, the authorized user is required to accurately memorize the encryption code without taking a memo thereof, which puts a very large burden on the user.

On the other hand, according to the recording data-protecting method disclosed in Japanese Laid-Open Patent Publication (Kokai) No. H07-21697, identification data ID is recorded in the lead-in area where it is difficult to carry out rewriting and copying, and the program is also recorded as recording data, which describes the process for determining whether the optical recording medium is the original medium or the copy medium based on whether the identification data ID exists in the lead-in area. This inhibits the start of the program (reproduction of the recording data) from the copy medium formed by unauthorized copying. However, it is technically possible to copy the various pieces of information in the lead-in area to another optical recording medium, which makes it practically meaningless to determine whether the optical recording medium is the original medium or the copy medium based on whether or not the identification data ID exists. Since it is practically difficult to determine whether the medium is the original medium or the copy medium, it is difficult to reliably protect the recording data.

Further, according to this recording data-protecting method, the pointer information and the author information are used as contents of the identification data ID. In this case, as described above, it is possible to copy the various pieces of information in the lead-in area into the lead-in area of the copy medium, and in addition, it is also technically possible to record recording data on the copy medium at recording locations made corresponding to those of the original medium. Therefore, the pointer information and author information recorded on the original medium and the pointer information and author information recorded on the copy medium can be easily made identical to each other. Therefore, when these pieces of information and the contents of the identification data ID are compared with each other, it is determined that the optical recording medium is the original medium in spite of the fact that it is actually the copy medium.

The present invention has been made to solve the above problems, and it is a main object of the invention to provide a recording data-recording method, a recording data-reproducing method, a recording device, a reproduction device, and a multilayer optical recording medium, which are capable of reliably restricting reproduction of recording data from an optical recording medium to which the recording data is copied, while reducing burden on an authorized user.

The recording data-recording method according to the present invention is a recording data-recording method for recording of recording data encrypted based on a predetermined encryption code on a multilayer optical recording medium comprising N (N is a natural number not smaller than 2) recording layers deposited on at least on one side of a substrate, wherein a distance between a first reference point in an M-th one (M is a natural number not larger than N) of the recording layers, as counted from an incident direction of a reproduction laser beam or a recording laser beam, and a second reference point in an L-th one (L is a natural number not larger than N and other than M) of the recording layers, as counted from the incident direction is obtained, and the recording data is encrypted using distance information enabling identification of the obtained distance as the encryption code.

According to the recording data-recording method, the distance between the first reference point in the M-th recording layer, as counted from the incident direction of the reproduction laser beam or the recording laser beam, and the second reference point in the L-th recording layer, as counted from the incident direction is obtained, and the recording data is encrypted using the distance information enabling identification of the obtained distance as the encryption code. Thus, the distance information which varies with each of multilayer optical recording media is used as the encryption code, so that even if the recording data encrypted based on the encryption code is copied to any other multilayer optical recording medium, distance information (encryption code used for decryption) in the copy of the multilayer optical recording medium, and the distance information (encryption code used for encryption) in the original multilayer optical recording medium do not coincide with each other. As a result, it is possible to restrict normal decryption of an unauthorized copy of the recoding data. Therefore, it is possible to reliably protect recording data (encrypted recording data) recorded on the original multilayer optical recording medium from unauthorized reproduction by a third party. Additionally, it is possible to encrypt and decrypt the recording data without inputting the encryption code, and hence largely reduce burden on the user.

In this case, it is preferred that the recording data-recording method wherein an angle of intersection of a first segment passing through one of the first reference point and the second reference point, and a third reference point in a K-th one (K is a natural number not larger than N and includes a same number equal to M or L) of the recording layers, as counted from the incident direction, and a second segment passing through the first reference point and the second reference point is obtained, and the recording data is encrypted using angle information enabling identification of the obtained angle as part of the encryption code. By virtue of this configuration, when compared with the method of encrypting recording data based on an encryption code based on the distance information alone, analysis of encryption of the recording data and decryption based on the results of analysis are made more difficult to perform, so that it is possible to more reliably protect the recording data from unauthorized reproduction thereof by a third party.

Further, it is preferred that program data is recorded which is read out by a reproduction device, and causes the reproduction device to obtain the distance between the first reference point and the second reference point as the encryption code, and decrypt the encrypted recording data based on the obtained encryption code. Now, the reproduction device in the present invention includes a single reproduction drive unit, and a whole system comprised of a reproduction drive unit and an electronic terminal unit connected to the reproduction drive unit. By virtue of this configuration, insofar a user owns a multilayer optical recording medium which has recording data recorded thereon by the recording data-recording method according to the present invention, it is possible to reliably reproduce (decrypt) the recording data encrypted and recorded on the multilayer optical recording medium.

Further, it is preferred that the program data is recorded in any one of a data recording area, a lead-in area, and a lead-out area in the multilayer optical recoding medium. By virtue of this configuration, a user who has purchased the multilayer optical recording medium can cause the program data to be recorded only when the recording data is recorded by the data-protecting method, which makes it possible to record recording data on each single type of multilayer optical recording medium by a desired one of the data-protecting method and the general method. Further, by recording the program data in any of the data-recording area, the lead-in area, and the lead-out area from which various reproduction devices can reliably read out recorded contents, it is possible to reliably read out the program data using the various reproduction devices other than the recording device which caused the program data to be recorded thereon. This makes it possible to reliably decrypt the encrypted recording data for reproduction. In this case, by recording the program data in either the lead-in area or the lead-out area, it becomes difficult to analyze the program data, so that it is possible to effectively prevent unauthorized rewriting of the program data.

Further, it is preferred that the program data is recorded in one of an area which is first accessed by the reproduction device when the multilayer optical recording medium is loaded, and an area designated by area information recorded in the area first accessed by the reproduction device. By virtue of this configuration, the program data is read out only by loading the multilayer optical recording medium in the reproduction device, which makes it possible to perform rapid reproduction when the multilayer optical recording medium from which the recording data is to be reproduced is the original medium, and reliably protect the recording data when the multilayer optical recording medium from which the recording data is to be reproduced is the copy medium.

Moreover, it is preferred that the program data is recorded as part of the encrypted recording data, or part of management information on the recording data. By virtue of this configuration, it becomes more difficult to analyze the program data, so that it is possible to more reliably prevent unauthorized rewriting of the program data.

The recording data-reproducing method according to the present invention is a recording data-reproducing method for decrypting and reproducing the recording data recorded by the recoding data-recording method described above, wherein the distance between the first reference point and the second reference point of the multilayer optical recording medium on which the recording data is recorded as an object to be reproduced is obtained, and the recording data is decrypted using distance information enabling identification of the obtained distance as the encryption code.

According to this recording data-reproducing method, after obtaining the distance between the first and second reference points of a multilayer optical recording medium on which recording data to be reproduced is recorded, the recording data is decrypted using distance information enabling identification of the distance, whereby insofar as the recording data to be reproduced is recorded on the original medium, it can be restored (decrypted) to the data structure identical to that before encryption, and if the recording data to be reproduced is recorded in the copy medium, it is restored to a data structure different from that before encryption, so that it is possible to reliably protect the recording data recorded on the original medium.

Further, it is preferred that an angle of intersection of the first segment and the second segment of the multilayer optical recording medium on which the recording data is recorded as the object to be reproduced is obtained, and the recording data is decrypted using angle information enabling identification of the obtained angle as part of the encryption code. By virtue of this configuration, also as to recording data which is encrypted using the angle information as part of the encryption code, it is possible to allow reproduction of the recording data from the original medium while reliably preventing unauthorized reproduction from the copy medium by a third party.

The recording device according to the present invention is a recording device that is capable of recording the recording data by the recording data-recording method described above, comprising a turntable that holds and rotates the multilayer optical recoding medium, a pickup that emits the reproduction laser beam or the recording laser beam to the multilayer optical recording medium held on the turntable, a moving mechanism that moves the pickup along a direction of radius of the multilayer optical recoding medium, and a control section that controls rotation of the turntable and motion of the pickup by the moving mechanism and executes encryption of the recording data based on the encryption code, wherein the control section causes the pickup to emit the reproduction laser beam to the M-th recording layer and the L-th recording layer while causing the turntable to rotate and the moving mechanism to move the pickup, calculates the distance between the first reference point and the second reference point based on a rotational angle of the turntable and an amount of movement of the pickup by the moving mechanism when the pickup emits the reproduction laser beam to the first reference point, and a rotational angle of the turntable and an amount of movement of the pickup by the moving mechanism when the pickup emits the reproduction laser beam to the second reference point, and encodes the recording data using distance information enabling identification of the calculated distance as the encryption code. Here, the control section in the present invention includes a control section contained in a recording drive unit, and a control section of an electronic terminal unit connected to the recording drive unit.

According to this recording device, there is calculated the distance between the first reference point and the second reference point based on the rotational angle of the turntable and the amount of movement of the pickup by the moving mechanism when the pickup emits the reproduction laser beam to the first reference point, and the rotational angle of the turntable and the amount of movement of the pickup by the moving mechanism when the pickup emits the reproduction laser beam to the second reference point, and the recording data is encoded using distance information enabling identification of the calculated distance as the encryption code, whereby even if the recording data encrypted based on the encryption code is copied to another multilayer optical recording medium, the distance information of the multilayer optical recording medium to which the recording data is copied and the distance information of the original multilayer optical recording medium do not coincide with each other, so that normal decryption of the illegally copied recording data can be restricted. Therefore, it is possible to reliably protect the recording data recorded on the original multilayer optical recording medium from being illegally reproduced by a third party.

The reproduction device according to the present invention is a reproduction device that is capable of reading out the recording data recorded by the recording data-recording method described above, from the multilayer optical recording medium to decrypt the recording data, and then reproducing the recoding data, comprising a turntable that holds and rotates the multilayer optical recoding medium, a pickup that emits the reproduction laser beam to the multilayer optical recording medium held on the turntable, a moving mechanism that moves the pickup along a direction of radius of the multilayer optical recoding medium, a storage section that stores program data which causes the reproduction device to obtain the distance between the first reference point and the second reference point as the encryption code, and decrypt the encrypted recording data based on the obtained encryption code, and a control section that controls rotation of the turntable and motion of the pickup by the moving mechanism, as well as obtains the encryption code and executes decryption of the recording data based on the obtained encryption code according to the program data, wherein the control section causes the pickup to emit the reproduction laser beam to the M-th recording layer and the L-th recording layer while causing the turntable to rotate and the moving mechanism to move the pickup, calculates the distance between the first reference point and the second reference point based on a rotational angle of the turntable and an amount of movement of the pickup by the moving mechanism when the pickup emits the reproduction laser beam to the first reference point, and a rotational angle of the turntable and an amount of movement of the pickup by the moving mechanism when the pickup emits the reproduction laser beam to the second reference point, and encodes the recording data using distance information enabling identification of the calculated distance as the encryption code. Here, the control section in the present invention includes a control section contained in a reproduction drive unit, and a control section of an electronic terminal connected to the reproduction drive unit.

According to the reproduction device, there is calculated the distance between the first reference point and the second reference point based on the rotational angle of the turntable and the amount of movement of the pickup by the moving mechanism when the pickup emits the reproduction laser beam to the first reference point, and the rotational angle of the turntable and the amount of movement of the pickup by the moving mechanism when the pickup emits the reproduction laser beam to the second reference point, and the recording data is encoded using distance information enabling identification of the calculated distance as the encryption code, whereby insofar as the recording data to be reproduced is recorded on the original medium, it is restored to the data structure before encryption, and if the recording data to be reproduced is recorded in the copy medium, it is restored to a data structure different from that before encryption, so that it is possible to reliably protect the recording data recorded on the original medium.

The multilayer optical recording medium according to the present invention is a multilayer optical recording medium that is capable of recording the recording data by the recording data-recording method described above, wherein program data is recorded which is read out by a reproduction device, and causes the reproduction device to obtain the distance between the first reference point and the second reference point as the encryption code, and decrypt the encrypted recording data based on the obtained encryption code.

According to this multilayer optical recording medium, program data is recorded which is read out by a reproduction device, and causes the reproduction device to obtain the distance between the first reference point and the second reference point as the encryption code, and decrypt the encrypted recording data based on the obtained encryption code, whereby it is possible to make it unnecessary for the user to carry out the processing of recording the program data, and hence it is possible to record the recording data promptly by the data-protecting method.

In this case, it is preferred that the program data is recorded in any one of a data recording area, a lead-in area, and a lead-out area in the multilayer optical recoding medium. By virtue of this configuration, it is possible, for example, to insure the compatibility with a general-purpose multilayer optical recording medium in which the user has written the program data.

Further, it is preferred that the program data is recorded in one of an area which is first accessed by the reproduction device when the multilayer optical recording medium is loaded, and an area designated by area information recorded in the area first accessed by the reproduction device. By virtue of this configuration, the program data is read out only by loading the multilayer optical recording medium in the reproduction device, which makes it possible to perform rapid reproduction when the multilayer optical recording medium from which the recording data is to be reproduced is the original medium, and reliably protect the recording medium when the multilayer optical recording medium from which the recording data is to be reproduced is the copy medium.

Further, it is preferred that the program data is recorded as pre-pits. By virtue of this configuration, it is possible to reliably prevent rewriting of the program data. Further, it is possible to make it unnecessary to perform the process of recording the program data on the multilayer optical recording medium, and hence it is possible to provide a multilayer optical recording medium which can perform recording of recording data by the data-protecting method promptly and easily. Further, the program data need not be stored in the storage section, and hence it is possible to sufficiently reduce the manufacturing costs of the recording device.

It should be noted that the present disclosure relates to the subject matter included in Japanese Patent Application No. 2002-100750 filed on Apr. 3, 2002, and it is apparent that all the disclosures therein are incorporated herein by reference.

### BRIEF DESCRIPTION OF DRAWINGS

FIG. 1 is a cross-sectional view showing the construction of a multilayer optical recording medium 1 according to an embodiment of the invention;

FIG. 2 is a conceptual diagram for explaining the positional relationship between a L1 recording layer 3 and a L0 recording layer 5 of the multilayer optical recording medium 1;

FIG. 3 is a block diagram showing the arrangement of a recording/reproduction device 11 according to the embodiment of the present invention, and a personal computer PC;

FIG. 4 is a flowchart of a data recording process 20 executed by the recording/reproduction device 11;

FIG. 5 is a flowchart of a data encrypting process 30 executed by the recording/reproduction device 11;

FIG. 6 is an explanatory view showing the positional relationship between reference points P3b, P5b, and P5a, a distance W, and an angle θ at the time of generation of an encryption code Dc;

FIG. 7 is an explanatory view for explaining a vector V to be identified based on the distance W and the angle θ; and

FIG. 8 is a flowchart of a data reproducing process 40 executed by the recording/reproduction device 11 and the personal computer PC.

### BEST MODE FOR CARRYING OUT THE INVENTION

Hereinafter, a recording data-recording method, a recording data-reproducing method, a recording device, a reproduction device, and a multilayer optical recording medium, according to a preferred embodiment of the present invention, will be described with reference to the accompanying drawings.

First of all, the construction of the multilayer optical recording medium 1 will be described with reference to the drawings.

The multilayer optical recording medium 1 shown in FIG. 1 is a single-sided two-layered rewritable optical recording medium, for example, and has an L1 recording layer 3, a spacer layer 4, an L0 recording layer 5, and a covering layer 6 sequentially deposited in the mentioned order on a substrate 2 in the form of a flat plate (e.g. in the form of a disk), with a mounting central hole H formed through a central portion thereof. The substrate 2 is made of a resin material, such as a polycarbonate, by injection molding, and a surface thereof toward the covering layer 6 is formed with fine protrusion/depression, such as helical grooves (guiding grooves) and lands. The L1 recording layer 3 is comprised of thin films layered on the fine protrusion/depression of the substrate, such as a reflective film for reflecting a recording laser beam and a reproduction laser beam (each of which is hereinafter also simply referred to as “the laser beam” when it is not required to make a distinction between the two laser beams), a phase change film whose optical reflectance is changed with a change in an optical constant caused by application of the recording laser beam, and a protective film for protecting the phase change film. The spacer layer 4 is formed of a light-transmitting resin, and a surface thereof toward the covering layer 6 is formed with fine protrusion/depression, such as helical grooves and lands. The L0 recording layer 5 is comprised of thin films layered on the fine protrusion/depression of the spacer layer 4, such as a phase change film and a protective film. The covering layer 6, which is for preventing the layers on the substrate 2 from being scratched or damaged, and for adjusting the thickness of the whole multilayer optical recording medium 1, is made of a light-transmitting resin. In the multilayer optical recording medium 1, the laser beam is applied in a direction indicated by an arrow X in FIG. 1, whereby recording of various digital data on the recording layers 3 and 5 or reading of various digital data from the recording layers 3 and 5 is performed. It should be noted that in the embodiment of the present invention, the L1 recording layer 3 will be described as the M-th recording layer in the present invention, and the L0 recording layer 5 as the L-th and K-th recording layers in the present invention, by way of example.

In the multilayer optical recording medium 1, the L0 recording layer 5 that records various digital data (recording data) thereon is comprised of a lead-in area 5a defined by a radially innermost portion thereof, and a data-recording area 5b defined radially outward of the lead-in area 5a, and the L1 recording layer 3 that similarly records various digital data (recording data) thereon is comprised of a lead-out area 3a defined by a radially innermost portion thereof, and a data-recording area 3b defined radially outward of the lead-out area 3a. In this case, in the lead-in area 5a, there are recorded management data Dt comprising at least physical format information on various digital data recorded on the data-recording areas 5b and 3b, FAT (File Allocation Table) data, and location data that designates a recording location of data first to be read out when the multilayer optical recording medium 1 is loaded in various reproduction devices (e.g. “TOC (Table Of Contents)” or “UTOC (User Table Of Contents)”). Further, in the data-recording areas 5b and 3b, there are recorded recording data Dd, Dd, . . . (not only sound data, image data, music data, and text data but also program data of various application software, and application data produced or updated by a user) encrypted through an encryption process, described hereinafter, decryption program data Dp corresponding to program data in the present invention, and so forth. It should be noted that actually, there sometimes exist known areas, such as PCA (Power Calibration Area), TA (Test Area), CA (Count Area), and PMA (Program Memory Area), farther radially inward of the lead-in area 5a, but detailed description thereof and illustration in figures are omitted.

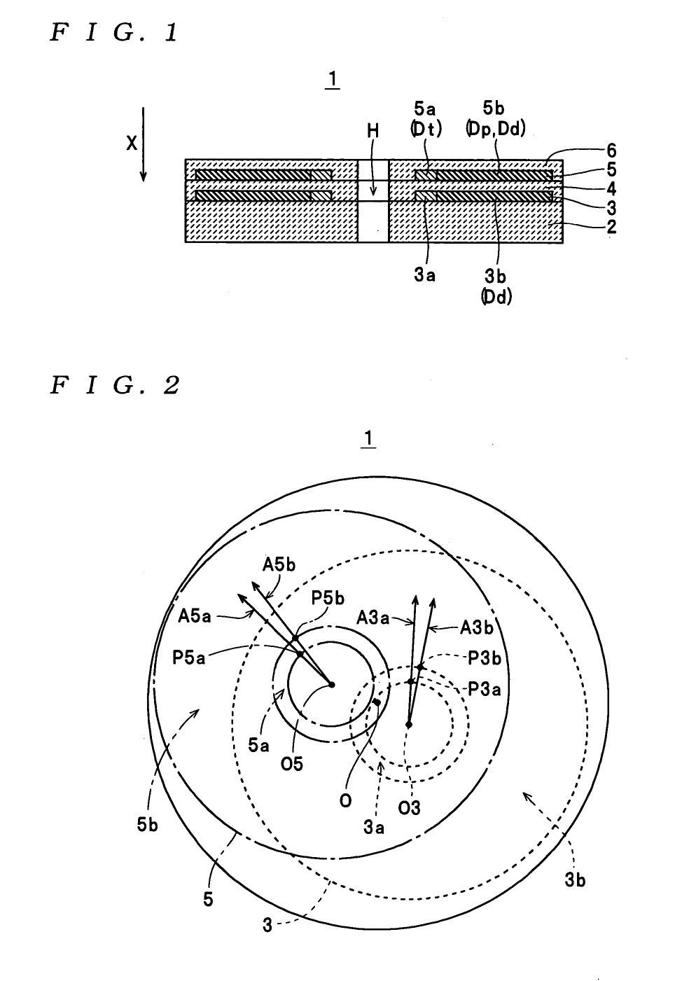

In this case, in manufacturing the multilayer optical recording medium 1, first, the L1 recording layer 3 is formed on the substrate 2 that has been formed by injection molding with fine protrusion/depression (e.g. grooves and lands) thereon. Then, after a light-transmitting resin is e.g. spin-coated on the L1 recording layer 3, the light-transmitting resin is cured with a stamper being placed thereon for forming fine protrusion/depression, whereby the spacer layer 4 is formed. Subsequently, after separation of the stamper, the L0 recording layer 5 is formed on the fine protrusion/depression of the spacer layer 4, and a light-transmitting resin is e.g. spin-coated to cover the L0 recording layer 5, and thereafter cured. Thus, the multilayer optical recording medium 1 is manufactured. Therefore, as shown in FIG. 2, in the multilayer optical recording medium 1, the center O5 of the L0 recording layer 5 (the center of the helical grooves and lands formed on the spacer layer 4) is off-center with respect to the center O3 of the L1 recording layer 3 (the center of the helical grooves and lands formed on the substrate 2) within a range of several tens of μm due to displacement of a position where the stamper is placed on the light-transmitting resin during formation of the spacer layer 4. Further, the centers O5 and O3 are also off-center with respect to the center O of the multilayer optical recording medium 1 (the center of mounting central hole H) within a range of several tens of μm due to misalignment occurring in forming the fine protrusion/depression and misalignment in forming the mounting central hole H during injection molding of the substrate 2. Further, the amount of eccentricity between the centers O5 and O3, and the amounts of eccentricities of the centers O5 and O3 with respect to the center O vary with each of the multilayer optical recording media 1, 1, . . . It should be noted that in FIG. 2, the amount of displacement between the L1 recording layer 3 and the L0 recording layer 5 is shown in an exaggerated manner for ease of understanding of the present invention.

Furthermore, the stamper is placed on the substrate 2, without the helical fine protrusion/depression of the stamper and the helical fine protrusion/depression in the L1 recording layer 3, already formed on the substrate 2, being completely overlaid upon each other. Therefore, a direction from the center O5 of the L0 recording layer 5 toward the starting location of the lead-in area 5a (the radially innermost portion of the lead-in area 5a: hereinafter also referred to as the “reference point P5a”) (direction indicated by an arrow A5a shown in the figure), and a direction from the center O3 of the L1 recording layer 3 toward the terminating location of the lead-out area 3a (the radially innermost portion of the lead-out area 3a: hereinafter also referred to as the “reference point P3a”) (direction indicated by an arrow A3a shown in the figure) do not necessarily coincide with each other, and moreover the amount of difference between these directions varies with each of the multilayer optical recording media 1, 1, . . . Similarly, a direction from the center O5 of the L0 recording layer 5 toward the starting location of the data-recording area 5b (the radially innermost portion of the data-recording area 5b: hereinafter also referred to as the “reference point P5b”) (direction indicated by an arrow A5b shown in the figure), and a direction from the center O3 of the L1 recording layer 3 toward the terminating location of the data-recording area 3b (the radially innermost portion of the data-recording area 3b: hereinafter also referred to as the “reference point P3b”) (direction indicated by an arrow A3b shown in the figure) do not necessarily coincide with each other, and moreover the amount of difference between these directions varies with each of the multilayer optical recording media 1, 1, . . . Accordingly, there are an infinite number of combinations of the above “amounts of eccentricities” and the “directions from the center O5 (O3) toward the reference points P5a and P5b (reference points P3a and P3b)”. Further, even if an attempt is made to form the L0 recording layer 5 and the L1 recording layer 3 with the same amounts of eccentricities and the same directions, as a matter of fact, it is very difficult to form them in such a state. Therefore, by using information enabling identification of the “amounts of eccentricities” and the “directions” as an encryption code, it is possible to provide an encryption code difficult to duplicate.

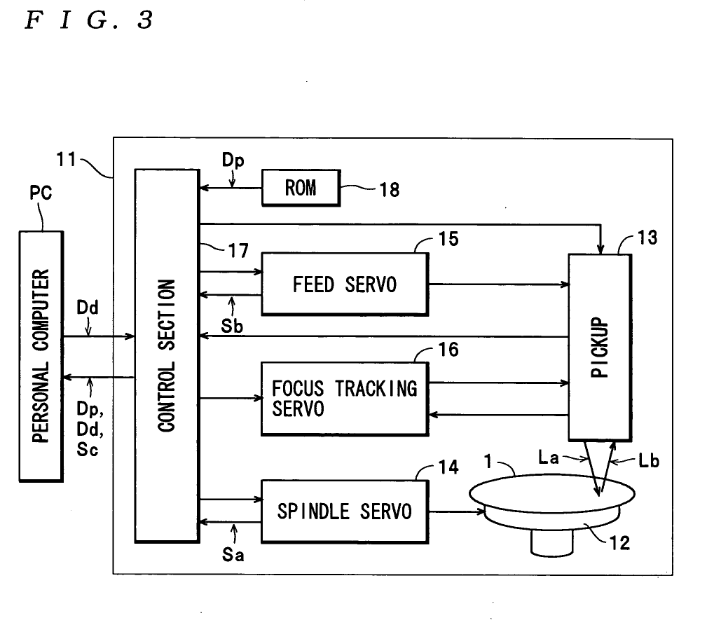

Next, a recording/reproduction device 11 and a personal computer PC, for performing recording of recording data on the multilayer optical recording medium 1 and reproduction of the recording data, will be described with reference to FIG. 3.

The recording/reproduction device 11 is e.g. an outboard drive unit that can be connected to the personal computer PC or the like, and configured to be capable of carrying out recording and reading of various digital data on and from the multilayer optical recording medium 1. The recording/reproduction device 11 corresponds to the recording device and the reproduction device in the present invention, and includes a turntable 12, a pickup 13, a spindle servo 14, a feed servo 15, a focus tracking servo 16, a control section 17, and a ROM 18. The turntable 12 is configured to be capable of having the multilayer optical recording medium 1 placed (chucked, i.e. held) thereon, and rotated together with the multilayer optical recording medium 1, at a constant linear velocity, by a spindle motor, not shown, controllably driven by the spindle servo 14.

The pickup 13 is configured to have a laser-emitting section and a laser-receiving section integrally formed with each other. When a laser, not shown, is driven by a laser driver, not shown, under the control of the control section 17, the pickup 13 emits a recording laser beam or a reproduction laser beam (emitted laser La) to the multilayer optical recording medium 1. As a result, recording of a signal on the multilayer optical recording medium 1, or delivery of an electric signal dependent on the level of a reflected laser Lb from a recorded location of the multilayer optical recording medium 1 is performed. Further, the pickup 13 includes an objective lens and a half mirror, neither of which is shown, and the focus tracking servo 16 performs the focus tracking control of the objective lens, whereby the laser beam is focused onto the L1 recording layer 3 or the L0 recording layer 5 of the multilayer optical recording medium 1. The pickup 13 is caused to reciprocate by the feed servo 15 along the direction of the radius of the multilayer optical recording medium 1 between the inner periphery and the outer periphery thereof.

The spindle servo 14 controls, under the control of the control section 17, the rotation of the turntable 12 such that the linear velocity thereof is constant. The spindle servo 14 delivers a rotation amount signal Sa dependant on the amount of the rotation of the turntable 12 (i.e. the amount of the rotation of the multilayer optical recording medium 1) to the control section 17. The feed servo 15 corresponds to a moving mechanism in the present invention, and causes the pickup 13 to reciprocate along the direction of the radius of the multilayer optical recording medium 1, as described above. The feed servo 15 delivers a movement amount signal Sb dependant on the amount of movement of the pickup 13 to the control section 17. The control section 17 controls the driving of the pickup 13, the spindle servo 14, the feed servo 15, and the focus tracking servo 16, and reads recording data recorded on the L1 recording layer 3 or the L0 recording layer 5 based on the electric signal delivered from the pickup 13. Further, the control section 17 calculates the existing position of the pickup 13 based on the rotation amount signal Sa and the movement amount signal Sb delivered from the spindle servo 14 and the feed servo 15, and delivers a position signal Sc dependent on the existing position to the personal computer PC. The ROM 18 has the decryption program data Dp recorded thereon, which is to be recorded on the multilayer optical recording medium 1 when the recording data Dd, Dd, . . . are recorded on the multilayer optical recording medium 1 by a data-protecting method, as will be described hereinafter.

In this case, the decryption program data Dp is data in which is described a program for decrypting the recording data Dd, Dd, . . . encrypted through a data-encrypting process 30, described hereinafter, by generating an encryption code Dc1 following the same procedure as followed when an encryption code Dc is generated during encryption of the recording data Dd, and decrypting the recording data Dd using the encryption code Dc1 according to an algorithm reverse in procedure to an algorithm used during the encryption. The decryption program data Dp is recorded in a file format readable by various types of personal computers, and contains a description for being automatically started by the personal computers immediately after completion of reading thereof. More specifically, the decryption program data Dp is comprised of executable files, such as AUTORUN.EXE, various batch files, and various module files that can be started by the executable files and the batch files.

The personal computer PC performs overall control of recording and reading of the recording data Dd, Dd, . . . and the like via the recording/reproduction device 11, and executes a predetermined decryption process according to a decryption program (contents of description of the decryption program data Dp) during reproduction of the recording data Dd, as described hereinafter.

Next, a description will be given of a recording method for recording the recording data Dd, Dd, . . . on the multilayer optical recording medium 1, which is unused, and a reproduction method for reproducing the recording data Dd, Dd, . . . recorded on the multilayer optical recording medium 1, with reference to the drawings. It should be noted that the following description of the embodiment of the present invention is given assuming that the reference point P3b is the first reference point in the present invention, the reference point P5b is the second reference point in the present invention, and the reference point P5a is the third reference point in the present invention.

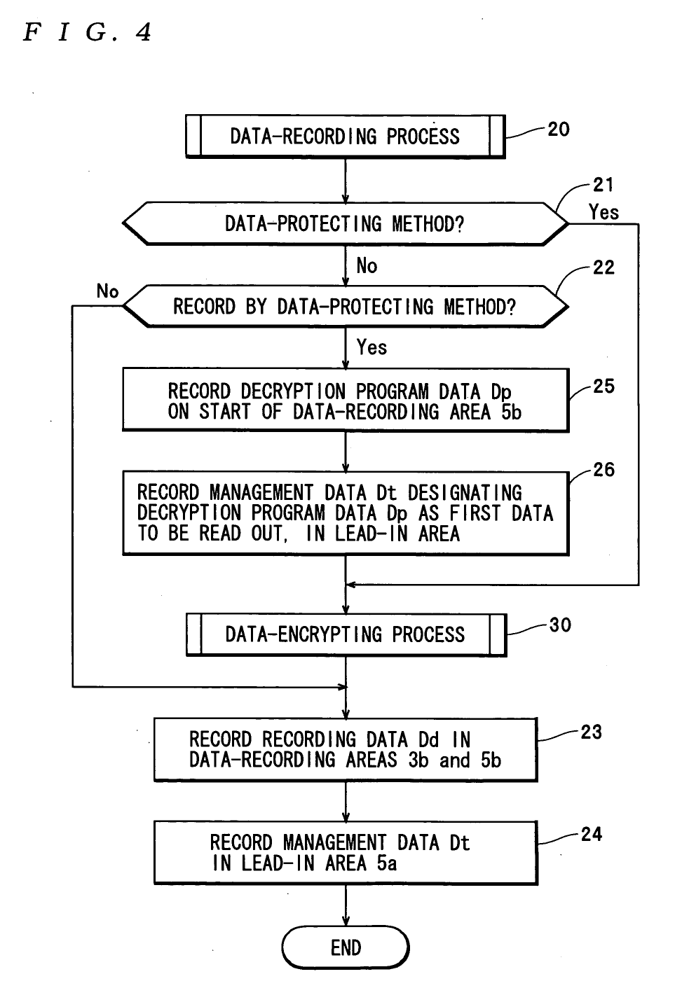

First, a data-recording process 20 carried out by the recording/reproduction device 11 and the personal computer PC will be described with reference to FIG. 4. In the recording/reproduction device 11, when a multilayer optical recording medium 1 is inserted into a disk-inserting section, not shown, the control section 17 controllably drives the spindle servo 14 to cause rotation of the turntable 12. Then, the control section 17 controllably drives the feed servo 15 to thereby move the pickup 13 to the radially innermost portion of the multilayer optical recording medium 1, and causes the reproduction laser beam (emitted laser La) to be emitted to the multilayer optical recording medium 1, while controllably driving the focus tracking servo 16. In this case, in the multilayer optical recording medium 1, various information items (in this case, these “various information items” are intended to mean not information directly used by the user, but information used by various recording devices or reproduction devices) including e.g. disk-type information that the optical recording medium is a rewritable (or write-once) medium of a single-sided two-layered type are recorded in the lead-in area 5a, an area farther radially inward of the lead-in area 5a, and the like. Therefore, the control section 17 determines that the multilayer optical recording medium 1 is a single-sided two-layered rewritable optical recording medium.

Then, the control section 17 controllably drives the feed servo 15 to move the pickup 13 to the lead-in area 5a, and determines whether or not the multilayer optical recording medium 1 is a medium having recording data recorded thereon by the data-protecting method, based on whether or not the decryption program data Dp is recorded in the data-recording area 5b (whether or not the management data Dt concerning the decryption program data Dp exists) (step 21). In this case, in the multilayer optical recording medium 1 on which are recorded recording data Dd, Dd, . . . encrypted through the data-encrypting process 30, described hereinafter, (the multilayer optical recording medium 1 having recording data recorded thereon by the data-protecting method), the decryption program data Dp is recorded in the starting area of the data-recording area 5b. Therefore, when the decryption program data Dp exists, the control section 17 determines that the multilayer optical recording medium 1 is a medium having recording data recorded thereon by the data-protecting method, and immediately executes the data-encrypting process 30 on recording data Dd, Dd, . . . to be recorded on the multilayer optical recording medium 1. On the other hand, in the data-recording area 5b of the multilayer optical recording medium 1, which is unused, is in a state not having the decryption program data Dp and recording data Dd recorded thereon. Accordingly, when the management data Dt concerning the decryption program data Dp does not exist in the lead-in area 5a, the control section 17 determines that the multilayer optical recording medium 1 is not a medium having recording data recorded thereon by the data-protecting method.

Subsequently, the control section 17 causes a selection screen to be displayed on a monitor of the personal computer PC, for allowing the user to select a method of recording of recording data on the multilayer optical recording medium 1, and prompts the user to select either of the data-protecting method and a normal recording method (step 22). In doing this, when the normal recording method is selected by the user, the control section 17 causes recording data Dd outputted from the personal computer PC to be recorded in the data-recording areas 3b and 5b of the multilayer optical recording medium 1 (step 23), and when all the recording data Dd, Dd, . . . have been recorded, causes the management data Dt indicating e.g. the respective recording locations of the recording data Dd, Dd, . . . to be recorded in the lead-in area 5a (step 24). Thus, recording data Dd, Dd, . . . (unencrypted recording data Dd) allowing reproduction thereof by all users including the authorized user are recorded on the multilayer optical recording medium 1. On the other hand, when the data-protecting method is selected in the step 22, the control section 17 reads out the decryption program data Dp from the ROM 18, and causes the same to be recorded on the starting portion of the data-recording area 5b (step 25). Then, the control section 17 causes FAT data concerning a recording location of the decryption program data Dp, location data designating the recording location of the decryption program data Dp as first data to be read out when the multilayer optical recording medium 1 is loaded in various reproduction devices including the recording/reproduction device 11, and so forth, to be recorded as part of the management data Dt e.g. in the lead-in area 5a (step 26).

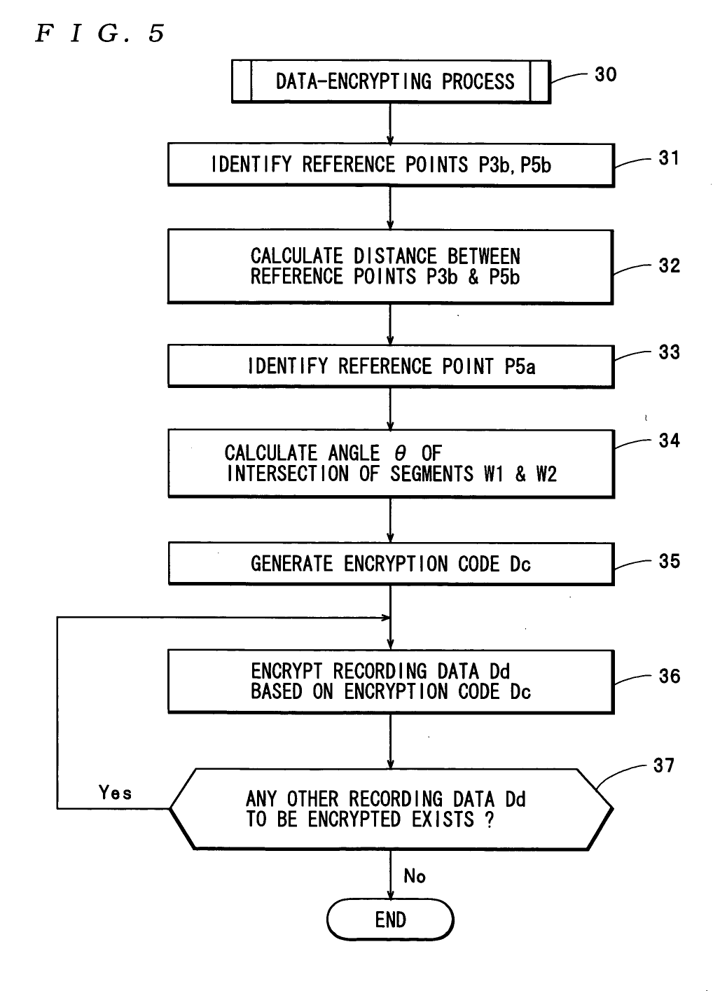

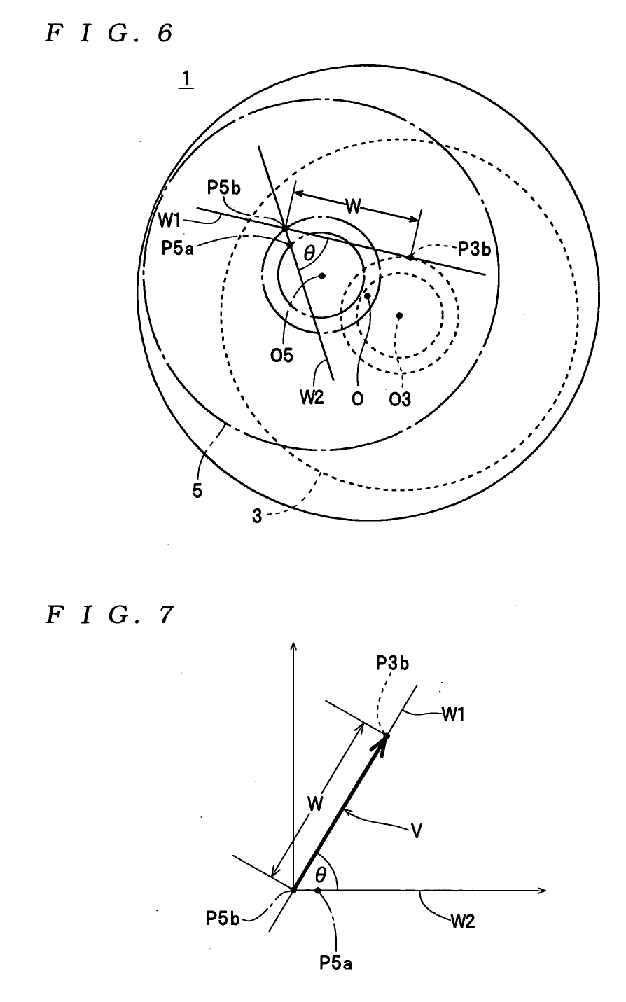

Next, the control section 17 executes the data-encrypting process 30 shown in FIG. 5 on the recording data Dd outputted from the personal computer PC. In the data-encrypting process 30, first, the control section 17 identifies the terminating location (reference point P3b) of the data-recording area 3b, and the starting location (reference point P5b) of the data-recording area 5b, based on the rotation amount signal Sa and the movement amount signal Sb delivered from the spindle servo 14 and the feed servo 15 (step 31). More specifically, the control section 17 identifies the location of the reference point P3b based on the rotation amount signal Sa and the movement amount signal Sb delivered when the pickup 13 has accessed the reference point P3b, and identifies the location of the reference point P5b based on the rotation amount signal Sa and the movement amount signal Sb delivered when the pickup 13 has accessed the reference point P5b. Then, the control section 17 calculates a distance W between the identified reference points P3b and P5b in plan view (see FIG. 6) (step 32). In this case, a three-dimensional distance including a thickness between the L1 recording layer 3 and the L0 recording layer 5 may be determined. Then, similarly to the method of identifying the reference points P3b and P5b, the control section 17 identifies the starting location (reference point P5a) of the lead-in area 5a based on the rotation amount signal Sa and the movement amount signal Sb (step 33). Next, the control section 17 calculates an angle θ of intersection of a segment W1 passing through the reference points P3b and P5b, and a segment W2 passing through the reference points P5b and P5a (see FIG. 6) (step 34).

In this case, as described hereinabove, the positional relationship between the reference points P3b, P5a, and P5b varies with each of the multilayer optical recording media 1, 1 . . . and hence the distance W between the reference points P3b and P5b and the angle θ of intersection of the segments W1 and W2 vary with each of the multilayer optical recording media 1, 1 . . . Further, since the locations of the reference points P3b, P5a, and P5b are not changed due to the recording or reproduction of the recording data Dd, the distance W and the angle θ determined from the same multilayer optical recording medium 1 always have the same values. In this case, since the mounting central hole H is formed to be slightly larger in diameter than the chuck, not shown, of the turntable 12, the positional relationship between the center of the turntable 12 and the center O of the multilayer optical recording medium 1 undergoes slight variation whenever the multilayer optical recording medium 1 is loaded. However, although the amount of the displacement (the amount of displacement caused by chucking) presents a problem for identifying the reference points P3b, P5a, and P5b individually, the amount of the displacement is cancelled out when the distance W and the angle θ are calculated (measured) based on the relative positional relationship between the reference points P3b, P5a, and P5b, and hence the result of the measurement is not adversely affected by the amount of the displacement. Therefore, information on the distance W and the angle θ is used as information peculiar to the multilayer optical recording medium 1. In this case, as shown in FIG. 7, the distance W and the angle θ are represented as a vector V whose axis is the segment W2, whose base point is the reference point P5b, whose length (scalar amount) is W, and whose direction is the angle θ. Therefore, in the recording/reproduction device 11, the control section 17 generates an encryption code Dc peculiar to the multilayer optical recording medium 1, using numerical information representing the vector V as the distance information and angle information in the present invention (step 35).

Next, the control section 17 alters (encrypts) the data structure of the recording data Dd using the generated encryption code Dc, according to a predetermined encryption algorithm (step 36). In this case, the recording data Dd encrypted based on the encryption code Dc is in a state made unrecognizable even if an attempt is made to directly view the contents of the recording data, whereby it is protected from unauthorized reproduction by a third party. Next, the control section 17 determines whether or not there exists another recording data Dd to be encrypted (step 37), and when all the recording data Dd, Dd, . . . have been encrypted, it completes the data-encrypting process 30. Subsequently, the control section 17 returns to the data-recording process 20 shown in FIG. 4 to cause the recording data Dd, Dd, . . . encrypted by the data-encrypting process 30 to be recorded in the data-recording areas 3b and 5b (step 23). Further, when all the recording data Dd, Dd, . . . have been recorded, the control section 17 performs recording (write-once) of e.g. respective recording locations of the recording data Dd, Dd, . . . , as part of the management data Dt, in the lead-in area 5a or the like (step 24). Thus, the recording data Dd, Dd, . . . are recorded on the multilayer optical recording medium 1 by the data-protecting method. In the following, the multilayer optical recording medium 1 having the recording data Dd, Dd, . . . recorded thereon by the data-protecting method is also referred to as the “original multilayer optical recording medium 1”.

Next, a data-reproducing process 40 for reproducing the recording data Dd, Dd, . . . recorded in the multilayer optical recording medium 1 using the recording/reproduction device 11 by the data-protecting method will be described with reference to drawings.

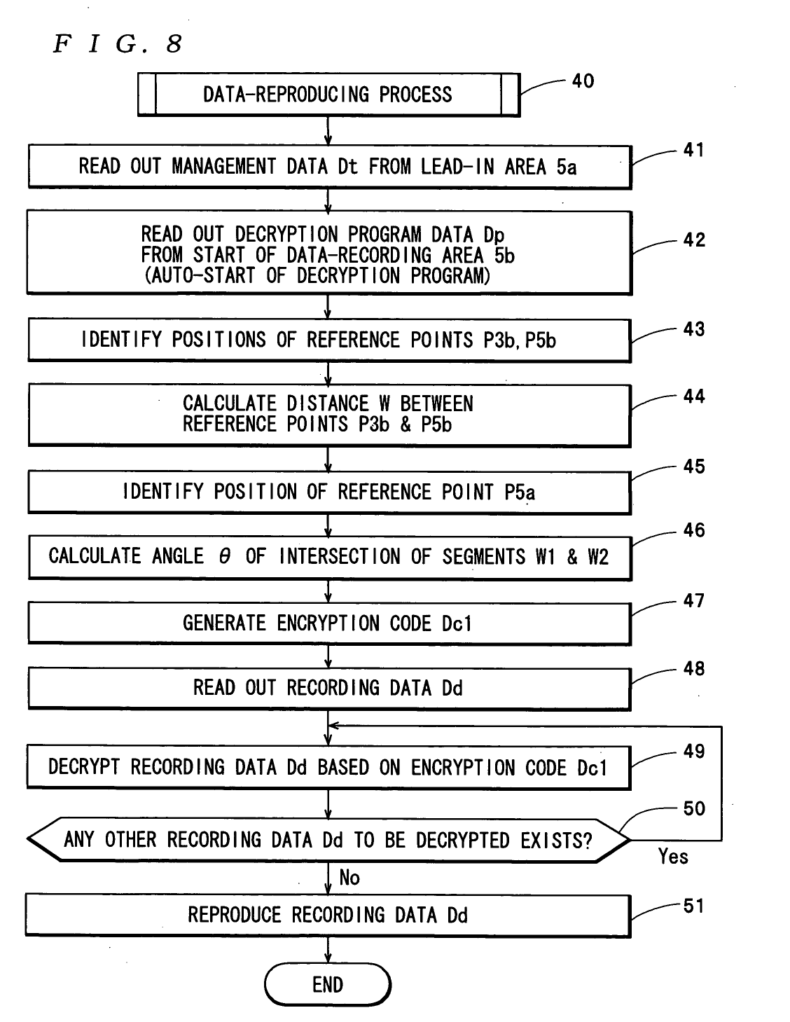

When the multilayer optical recording medium 1, on which are recorded the recording data Dd, Dd, . . . encrypted through the data-encrypting process 30 described above and the decryption program data Dp, is loaded in the recording/reproduction device 11 (or any other recording/reproduction device), the data-reproducing process 40 shown in FIG. 8 is executed. In the data-reproducing process 40, when the multilayer optical recording medium 1 is inserted, first, the control section 17 reads out the management data Dt from the lead-in area 5a (step 41). In this case, on the management data Dt, there is recorded the location data designating the recording location (in this case, the start of the data-recording area 5b) of the decryption program data Dp as first data to be read out. Therefore, the control section 17 reads out the decryption program data Dp from the head of the data-recording area 5b in accordance with the designation (step 42), and transfers the decryption program data Dp to the personal computer PC. In this case, since the decryption program data Dp is formed in the file format automatically started immediately after completion of reading of the decryption program data Dp, the personal computer PC automatically executes the contents of description of the decryption program data Dp read out via the recording/reproduction device 11 (starts the decryption program).

Then, the personal computer PC identifies, according to the description of the decryption program data Dp, the locations of the reference points P3b and P5b of the multilayer optical recording medium 1 loaded in the recording/reproduction device 11. More specifically, first, the personal computer PC requests the recording/reproduction device 11 to deliver the position signal Sc. The control section 17 of the recording/reproduction device 11 identifies, in response to the request, the location of the reference point P3b based on the rotation amount signal Sa and the movement amount signal Sb delivered when the pickup 13 has accessed the reference point P3b, and identifies the location of the reference point P5b based on the rotation amount signal Sa and the movement amount signal Sb delivered when the pickup 13 has accessed the reference point P5b. Next, the control section 17 delivers the position signal Sc indicating the respective locations of the identified reference points P3b and P5b to the personal computer PC. The personal computer PC identifies the locations of the reference points P3b and P5b based on the delivered position signal Sc (step 43), and then calculates the distance W between the identified reference points P3b and P5b (step 44). Subsequently, the personal computer PC identifies the location of the reference point P5a based on the position signal Sc, similarly to the identification of the reference points P3b and P5b (step 45). Then, the personal computer PC calculates the angle θ of intersection of the segment W1 passing through the reference points P3b and P5b and the segment W2 passing through the reference points P5b and P5a (step 46). After that, the personal computer PC generates numerical information representative of the vector V defined by the calculated distance W and angle θ as the encryption code Dc1 (step 47).

Next, the personal computer PC reads out the recording data Dd from the data-recording area 5b of the multilayer optical recording medium 1 loaded in the recording/reproduction device 11 (step 48). Then, the personal computer PC reconstructs the data structure of the recording data Dd (decrypts the recording data Dd) according to a predetermined algorithm (reverse in procedure to the encryption algorithm used in the data-encrypting process 30) in accordance with the contents of description of the decryption program data Dp, using the encryption code Dc1 generated in the step 47 (step 49). In doing this, if a copy medium, which has the recording data Dd, Dd . . . , and the decryption program data Dp copied thereon from the original multilayer optical recording medium 1, is loaded in the recording/reproduction device 11, the reference points P3b, P5b, P5a used as the basis for generation of the encryption code Dc1 are formed at locations different from those of the original multilayer optical recording medium 1, so that the encryption code Dc generated based on the reference points P3b, P5b, and P5a recorded on the original multilayer optical recording medium 1 (encryption code Dc used in encrypting the recording data Dd), and the encryption code Dc1 generated based on the reference points P3b, P5b, and P5a in the multilayer optical recording medium 1 as the copy medium are different from each other. Accordingly, when the recording data Dd encrypted based on the encryption code Dc is decrypted based on the encryption code Dc1, the decrypted recording data Dd is largely different in data structure from the recording data Dd unencrypted. As a result, the decrypted recording data Dd cannot be normally reproduced, and even if the contents of the recording data are directly viewed by various types of editors, they are completely illegible. This makes it possible to reliably restrict unauthorized reproduction of the recording data Dd, Dd, . . . recorded on the original multilayer optical recording medium 1 (reproduction of the recording data Dd, Dd, . . . from the copy of the multilayer optical recording medium 1).

On the other hand, in the same multilayer optical recording medium 1, the reference points P3b, P5b, and P5a used as the basis for generation of the encryption codes Dc and Dc1 are fixed, and the distance W and the angle θ calculated based thereon are the values peculiar to the multilayer optical recording medium 1. Hence, the encryption code Dc (Dc1) generated based on the reference points P3b, P5b, and P5a in the original multilayer optical recording medium 1 always has the same value, even if the encryption code Dc (Dc1) is generated by any reproduction device and in any fashion. Therefore, when the original multilayer optical recording medium 1 is loaded in the recording/reproduction device 11, the encryption code Dc1 and the encryption code Dc have the same value. This means that when the recording data Dd encrypted based on the encryption code Dc is decrypted based on the encryption code Dc1, the decrypted recording data Dd has the same data structure as that of the recording data Dd before encryption. This makes it possible to reproduce the recording data Dd read out from the multilayer optical recording medium 1. After that, the control section 17 determines whether or not there exists any other recording data Dd, Dd, . . . to be decrypted (step 50), and when decryption of all the recording data Dd, Dd, . . . has been completed, the control section 17 reproduces the recording data Dd, Dd, . . . (step 51).

In this case, also when the multilayer optical recording medium 1 is loaded in any other arbitrary reproduction device (or recording/reproduction device) in place of the personal computer PC and the recording/reproduction device 11 used in recording encrypted recording data Dd on the multilayer optical recording medium 1, the data-reproducing process 40 is carried out by the reproduction device (or recording/reproduction device). As a result, reproduction of the recording data Dd, Dd, . . . , for example, from an unauthorized copy of the multilayer optical recording medium 1 is inhibited, whereby the recording data Dd, Dd, . . . recorded on the original multilayer optical recording medium 1 are protected.

As described hereinabove, according to the recording/reproduction device 11, when recording data Dd is recorded on the multilayer optical recording medium 1 by the data-protecting method, the recording data Dd is encrypted using the peculiar encryption code Dc generated based on the reference points P3b, P5b, and P5a in the original multilayer optical recording medium 1, and not only the decryption program data Dp but also the management data Dt designating the decryption program data Dp to be read first is recorded, whereby when the multilayer optical recording medium 1 is reproduced, the recording data Dd is decrypted in accordance with the contents of description of the decryption program data Dp, using the encryption code Dc1 generated based on the reference points P3b, P5b, and P5a in the multilayer optical recording medium 1. Accordingly, in a multilayer optical recording medium 1 (copy medium) different in the positional relationship between the reference points P3b, P5b, and P5a from that of the original multilayer optical recording medium 1, normal decryption of the recording data Dd is not executed, so that it is possible to effectively inhibit reproduction of the recording data Dd from a multilayer optical recording medium 1 to which the recording data Dd has been illegally copied from the original multilayer optical recording medium 1. In this case, although in the conventional recording data-protecting method based on the encryption, when recording data is decrypted, the user is prompted to input an encryption code used in encrypting the recording data, in the present recording data-recording method (recording data-protecting method) using the recording/reproduction device 11, the positional relationship (numerical information indicative of the vector V) between the reference points P3b, P5b, and P5a in the multilayer optical recording medium 1, which has recording data Dd to be protected recorded thereon, is used as the encryption code Dc. Therefore, the user need not input an encryption code either during encryption or during decryption of recording data Dd. This makes it unnecessary for the user to memorize the encryption code, thereby making it possible to record (encrypt) and reproduce (decrypt) recording data Dd reliably and easily, only by selecting the data-protecting method for recording the recording data Dd when it is recorded.

Further, according to the recording/reproduction device 11, by recording the decryption program data Dp in the data-recording area 5b, when the multilayer optical recording medium 1 having recording data recorded thereon by the data-protecting method is recorded on another multilayer optical recording medium 1 by a general copying method, the decryption program data Dp is copied on the data-recording area 5b of a copy medium. Therefore, when the copy medium is reproduced, the recording data Dd is decrypted according to the description of the decryption program data Dp. In the process, as described hereinbefore, recording data Dd largely different in data structure from the recording data Dd before encryption is generated. This makes it impossible to properly reproduce the recording data Dd, thereby making it possible to reliably protect the recording data Dd recorded on the original multilayer optical recording medium 1. In this case, by recording the decryption program data Dp in the data-recording area 5b from which various types of reproduction devices can reliably read out recording data Dd and the like, the decryption program data Dp can be reliably read out from the original multilayer optical recording medium 1 by various types of reproduction devices other than the recording/reproduction device (the recording/reproduction device 11 in this case) used in recording the decryption program data Dp on the multilayer optical recording medium 1. This makes it possible to reliably decrypt and reproduce the encrypted recording data Dd, Dd, . . . .

It should be noted that the present invention is by no means limited to the aforementioned embodiment but it can be modified as required. For example, although in the above-described embodiment of the present invention, the description has been given of an example in which the decryption program data Dp is recorded on an unused multilayer optical recording medium 1 when recording data Dd is recorded by the data-protecting method, this is not limitative, but it is also possible to record the decryption program data Dp in advance on each multilayer optical recording medium 1, 1, . . . e.g. as pre-pits, when the multilayer optical recording media are manufactured. According to this method, it is unnecessary not only to write the decryption program data Dp during recording of recording data Dd but also to have the decryption program data Dp recorded in advance on a recording device, whereby it is possible to increase the speed of recording processing and reduce the manufacturing costs of the recording device. This makes it possible to provide the user with a multilayer optical recording medium 1 capable of effectively protecting recording data. Further, it is also possible to store the decryption program data Dp in advance in various reproduction devices instead of recording the same on the multilayer optical recording medium 1 as described in the embodiment of the present invention. In this case, there is no need to record the decryption program data Dp on the multilayer optical recording medium 1 (including a case where the decryption program data Dp is recorded during recording of recording data as well as a case where the decryption program data Dp is recorded during manufacturing of the multilayer optical recording medium 1), and further it is possible to record a larger amount of recording data Dd, Dd, . . . on the multilayer optical recording medium 1, by the amount required for recording the decryption program data Dp.

Furthermore, although in the above-described embodiment of the present invention, the description has been given of an example in which recording data Dd is encrypted according to the predetermined encryption algorithm using the encryption code Dc, the encryption algorithm is not limited to one kind of algorithm, and it is possible to make analysis of encrypted recording data Dd more difficult by changing the algorithm for each of multilayer optical recording media 1, 1, . . . In this case, by changing an algorithm (reverse in procedure to an encryption algorithm) described in decryption program data Dp according to a change in the encryption algorithm, it is possible to reliably decrypt encrypted recording data Dd while making it difficult for a third party to analyze the encrypted recording data Dd.

Further, although in the above-described embodiment, the description has been given of an example in which the encryption code Dc is generated based on the starting location (reference point P5b) of the data-recording area 5b, the terminating location (reference point P3b) of the data-recording area 3b, and the starting location (reference point P5a) of the lead-in area 5a, the first, second, and third reference points in the present invention are not limited to the starting location and the terminating location of the data-recording areas, and the starting location of the lead-in area. For example, the encryption code Dc can be generated based on arbitrary reference points in the multilayer optical recording medium 1, such as the center O3 of the L1 recording area 3, the center O5 of the L0 recording area 5, the terminating location (reference point P3a) of the lead-out area 3a, the terminating location of the data-recording area 3b, and the starting location of the data-recording area 5b, and arbitrary reference points exclusively defined for manufacturing the multilayer optical recording medium 1. Furthermore, although in the above-described embodiment, the description has been given of an example in which the encryption code Dc is generated based on the distance W between the reference points P3b and P5b, and the angle θ of intersection of the segments W1 and W2, this is not limitative, but the encryption code Dc may be generated based only on distance information enabling identification of the distance W. In such a case as well, the distance W between the reference points P3b and P5b varies with each of the multilayer optical recording media 1, 1 . . . , and hence it is possible to effectively inhibit reproduction of recording data Dd from a copy of the multilayer optical recording medium 1, similarly to the encryption code Dc generated based on the segment W1 and the angle θ.

Further, although in the above-described embodiment of the present invention, the description has been given of an example in which all the recording data Dd, Dd, . . . recorded on the multilayer optical recording medium 1 are encrypted by using the encryption code Dc, this is not limitative, but it is possible, for example, to prompt the user to arbitrarily select recording data Dd, Dd, . . . which needs to be encrypted, to thereby encrypt only selected recording data Dd, Dd, . . . for recording. In doing this, by recording information enabling identification of either or both of recording locations of the encrypted recording data Dd, Dd . . . and recording locations of recording data Dd, Dd, . . . recorded without being encrypted, as part of the management data Dt, even if both types of recording data, i.e. encrypted recording data Dd, Dd . . . and unencrypted recording data Dd, Dd, . . . are recorded in a mixed manner on one multilayer optical recording medium 1, it is possible to reproduce both types of recording data Dd, Dd, . . . reliably and easily. In this case, for example, by dividing the data-recording areas 5b and 3b of the multilayer optical recording medium 1 into a recording area for recording the encrypted recording data Dd, and a recording area for recording the unencrypted recording data Dd (e.g. setting the data-recording area 5b to the recording area for recording the encrypted recording data Dd, and the data-recording area 3b to the recording area for recording the unencrypted recording data Dd), it is possible to record and reproduce both types of recording data Dd, Dd, . . . easily.

Further, although in the above-described embodiment of the present invention, the description has been given of the rewritable multilayer optical recording medium 1 including the L1 recording layer 3 and the L0 recording layer 5 both having a phase change film, this is not limitative, but the present invention can also be effectively applied to a write-once multilayer optical recording medium including recording layers made of various inorganic materials and organic dye-based materials. Furthermore, the number of recording layers of the multilayer optical recording medium (N recording layers, in the present invention) is not limited to the two of the L1 recording layer 3 and the L0 recording layer 5 described in the aforementioned embodiment, but the present invention can also be applied to a multilayer optical recording medium including three or more recording layers. Further, the recording location of the decryption program data Dp is not limited to the data-recording area 5b described in the above embodiment, but the decryption program data Dp can be recorded in a desired area which can be accessed by the reproduction device. Furthermore, although in the above-described embodiment, the description has been given of an example in which the ROM 18 is provided in the recording/reproduction device 11, and the decryption program data Dp is read out from the ROM 18 and recorded on the multilayer optical recording medium 1, the location for storing the decryption program data Dp is not limited to the recording/reproduction device 11, but the decryption program data Dp may be recorded in advance on a hard disk of the personal computer PC, whereby the data Dp may be caused to be transmitted from the personal computer PC and recorded on the multilayer optical recording medium 1 when recording data Dp is recorded by the data-protecting method (when the data-recording process 20 is carried out).

Further, although in the above-described embodiment, the description has been given of an example in which the encryption process and the decryption process is carried out in accordance with the contents of description of the decryption program data Dp on the personal computer PC, this is not limitative, but for example, it is also possible to produce a decryption program that is executable in the recording/reproduction device 11 and record decryption program data of the decryption program on the multilayer optical recording medium 1. Furthermore, although in the above-described embodiment, the description has been given of the recording/reproduction device 11 which is an outboard drive unit capable of being connected to the personal computer PC, by way of example, this not limitative, but the present invention can be applied to various types of recording devices, such as a built-in drive capable of being contained in the personal computer PC, an AV recording/reproduction device capable of recording and reproducing video images and music by the device alone, and a CD recorder capable of producing and reproducing music CD-R by the device alone.

### INDUSTRIAL APPLICABILITY

As described heretofore, according to the recording data-recording method, the distance between a first reference point in an M-th recording layer, as counted from an incident direction of a reproduction laser beam or a recording laser beam, and a second reference point in an L-th recording layer, as counted from the incident direction is obtained, and recording data is encrypted using distance information enabling identification of the obtained distance as an encryption code. Thus, the distance information which varies with each of multilayer optical recording media is used as an encryption code, so that even if the recording data encrypted based on the encryption code is copied to any other multilayer optical recording medium, distance information (encryption code used for decryption) in the copy of the multilayer optical recording medium, and distance information (encryption code used for encryption) in the original multilayer optical recording medium do not coincide with each other. As a result, it is possible to restrict normal decryption of an unauthorized copy of the recoding data. Therefore, it is possible to reliably protect recording data (encrypted recording data) recorded on the original multilayer optical recording medium from unauthorized reproduction by a third party. Additionally, it is possible to encrypt and decrypt the recording data without inputting the encryption code. This makes it possible to realize a recording data-recording method which is capable of reliably restricting reproduction of the recording data from the copy of the optical recording medium while reducing burden on the authorized user.

1. A recording data-recording method for recording of recording data encrypted based on a predetermined encryption code on a multilayer optical recording medium comprising N (N is a natural number not smaller than 2) recording layers deposited on at least on one side of a substrate,
wherein a distance between a first reference point in an M-th one (M is a natural number not larger than N) of the recording layers, as counted from an incident direction of a reproduction laser beam or a recording laser beam, and a second reference point in an L-th one (L is a natural number not larger than N and other than M) of the recording layers, as counted from the incident direction is obtained, and the recording data is encrypted using distance information enabling identification of the obtained distance as the encryption code.

2. The recording data-recording method as claimed in claim 1,
wherein an angle of intersection of a first segment passing through one of the first reference point and the second reference point, and a third reference point in a K-th one (K is a natural number not larger than N and includes a same number equal to M or L) of the recording layers, as counted from the incident direction, and a second segment passing through the first reference point and the second reference point is obtained, and the recording data is encrypted using angle information enabling identification of the obtained angle as part of the encryption code.

3. The recording data-recording method as claimed in claim 1,
wherein program data is recorded which is read out by a reproduction device, and causes the reproduction device to obtain the distance between the first reference point and the second reference point as the encryption code, and decrypt the encrypted recording data based on the obtained encryption code.

4. The recording data-recording method as claimed in claim 2,
wherein program data is recorded which is read out by a reproduction device, and causes the reproduction device to obtain the distance between the first reference point and the second reference point as the encryption code, and decrypt the encrypted recording data based on the obtained encryption code.

5. The recording data-recording method as claimed in claim 3,
wherein the program data is recorded in any one of a data recording area, a lead-in area, and a lead-out area in the multilayer optical recoding medium.

6. The recording data-recording method as claimed in claim 4,
wherein the program data is recorded in any one of a data recording area, a lead-in area, and a lead-out area in the multilayer optical recoding medium.

7. The recording data-recording method as claimed in claim 3,
wherein the program data is recorded in one of an area which is first accessed by the reproduction device when the multilayer optical recording medium is loaded, and an area designated by area information recorded in the area first accessed by the reproduction device.

8. The recording data-recording method as claimed in claim 5,
wherein the program data is recorded in one of an area which is first accessed by the reproduction device when the multilayer optical recording medium is loaded, and an area designated by area information recorded in the area first accessed by the reproduction device.

9. The recording data-recording method as claimed in claim 3,
wherein the program data is recorded as part of the encrypted recording data, or part of management information on the recording data.

10. The recording data-recording method as claimed in claim 5, wherein the program data is recorded as part of the encrypted recording data, or part of management information on the recording data.

11. The recording data-recording method as claimed in claim 7,
wherein the program data is recorded as part of the encrypted recording data, or part of management information on the recording data.

12. A recording data-reproducing method for decrypting and reproducing the recording data recorded by the recoding data-recording method claimed in claim 1,
wherein the distance between the first reference point and the second reference point of the multilayer optical recording medium on which the recording data is recorded as an object to be reproduced is obtained, and the recording data is decrypted using distance information enabling identification of the obtained distance as the encryption code.

13. The recording data-reproducing method as claimed in claim 12,
wherein an angle of intersection of the first segment and the second segment of the multilayer optical recording medium on which the recording data is recorded as the object to be reproduced is obtained, and the recording data is decrypted using angle information enabling identification of the obtained angle as part of the encryption code.

14. A recording device that is capable of recording the recording data by the recording data-recording method claimed in claim 1 comprising:
a turntable that holds and rotates the multilayer optical recoding medium, a pickup that emits the reproduction laser beam or the recording laser beam to the multilayer optical recording medium held on said turntable, a moving mechanism that moves said pickup along a direction of radius of the multilayer optical recoding medium, and a control section that controls rotation of said turntable and motion of said pickup by said moving mechanism and executes encryption of the recording data based on the encryption code,
wherein said control section causes said pickup to emit the reproduction laser beam to the M-th recording layer and the L-th recording layer while causing said turntable to rotate and said moving mechanism to move said pickup, calculates the distance between the first reference point and the second reference point based on a rotational angle of said turntable and an amount of movement of said pickup by said moving mechanism when said pickup emits the reproduction laser beam to the first reference point, and a rotational angle of said turntable and an amount of movement of said pickup by said moving mechanism when said pickup emits the reproduction laser beam to the second reference point, and encodes the recording data using distance information enabling identification of the calculated distance as the encryption code.

15. A reproduction device that is capable of reading out the recording data recorded by the recording data-recording method claimed in claim 1, from the multilayer optical recording medium to decrypt the recording data, and then reproducing the recoding data, comprising:
a turntable that holds and rotates the multilayer optical recoding medium, a pickup that emits the reproduction laser beam to the multilayer optical recording medium held on said turntable, a moving mechanism that moves said pickup along a direction of radius of the multilayer optical recoding medium, a storage section that stores program data which causes the reproduction device to obtain the distance between the first reference point and the second reference point as the encryption code, and decrypt the encrypted recording data based on the obtained encryption code, and a control section that controls rotation of said turntable and motion of said pickup by said moving mechanism, as well as obtains the encryption code and executes decryption of the recording data based on the obtained encryption code according to the program data,
wherein said control section causes said pickup to emit the reproduction laser beam to the M-th recording layer and the L-th recording layer while causing said turntable to rotate and said moving mechanism to move said pickup, calculates the distance between the first reference point and the second reference point based on a rotational angle of said turntable and an amount of movement of said pickup by said moving mechanism when said pickup emits the reproduction laser beam to the first reference point, and a rotational angle of said turntable and an amount of movement of said pickup by said moving mechanism when said pickup emits the reproduction laser beam to the second reference point, and encodes the recording data using distance information enabling identification of the calculated distance as the encryption code.

16. A multilayer optical recording medium that is capable of recording the recording data by the recording data-recording method claimed in claim 1,
wherein program data is recorded which is read out by a reproduction wdevice, and causes the reproduction device to obtain the distance between the first reference point and the second reference point as the encryption code, and decrypt the encrypted recording data based on the obtained encryption code.

17. The multilayer optical recording medium as claimed in claim 16,
wherein the program data is recorded in any one of a data recording area, a lead-in area, and a lead-out area in the multilayer optical recoding medium.

18. The multilayer optical recording medium as claimed in claim 16,
wherein the program data is recorded in one of an area which is first accessed by the reproduction device when the multilayer optical recording medium is loaded, and an area designated by area information recorded in the area first accessed by the reproduction device.

19. The multilayer optical recording medium as claimed in claim 17,
wherein the program data is recorded in one of an area which is first accessed by the reproduction device when the multilayer optical recording medium is loaded, and an area designated by area information recorded in the area first accessed by the reproduction device.

20. The multilayer optical recording medium as claimed in claim 16,
wherein the program data is recorded as pre-pits.

21. The multilayer optical recording medium as claimed in claim 17,
wherein the program data is recorded as pre-pits.

22. The multilayer optical recording medium as claimed in claim 18,
wherein the program data is recorded as pre-pits.

23. The multilayer optical recording medium as claimed in claim 19,
wherein the program data is recorded as pre-pits.
